(19) United States
(12) Patent Application Publication
(10) Pub. No.: US 2005/0065960 A1
(43) Pub. Date: Mar. 24, 2005

(54) Method and system of data management

(76) Inventors: Jen-Lin Chao, Hsinchu (TW); Fa-Liang Wang, Hsinchu City (TW); Cheng-Hwa Liu, Hsinchu City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/666,503

(22) Filed: Sep. 19, 2003

(51) Int. Cl. G06F 17/00

(52) U.S. Cl. 707/102

(57) ABSTRACT

A system of data management. The system includes a data verification module, a data notation module, and a data management module. The data verification module verifies the data records according to the data correlations and produces verification results, each of which corresponds to a data record. The data notation module notes the verification results in the corresponding data records. The data management module manages the data records according to the verification results.

### BACKGROUND OF THE INVENTION

1. Field of the Invention

The present invention relates to data management technology, and in particular to a system of managing a plurality of correlated data records.

2. Description of the Related Art

A data application system can be divided into data application programs and applied data. Compared to the applied data, the application programs may be time-consuming but less complicated than the applied data, which, prepared by data owners, is generally distributed among different fields, such as operators or customers. Thus, regarding a data application system establishment in an enterprise, finished application programs frequently must await data preparation for a long time.

Three main issues affect data preparation of a data application system. The first is data correction, the second data integrity, and the third data validity, verification by which the applied data must undergo prior to application into the data application programs. Data correction ensures that the applied data that which the data application programs require. Data integrity fully checks data correlations, and data validity determines that applied data is still in its effective period.

For example, if a data application program requires an order list as its applied data, the order list is the correct applied data. A customer list and a product list may both have been combined to produce the order list, so both must be checked before applying the order list to the data application program. Finally, if the orders change once a month, then the effective period of the order list is one month.

The difficulties described become more serious in a large enterprise, in which applied data of a data application system is stored in database, utilizing management tools provided thereby. However, conventional management tools provided by the databases focus solely on the applied data, not the requirements of the data application system, frequently causing data inaccuracy.

U.S. Pat. No. 6,345,270 discloses a data management system allowing various forms of data to be centrally managed. However, the methods and systems disclosed are dictated by the aspects of the data, rather than correlations required by the data application system. Thus, the invention is not suitable for application to a data application system, especially for large enterprises.

### SUMMARY OF THE INVENTION

Accordingly, an object of the invention is to provide a system of data management verifying applied data for a data application system considering the requirements thereof.

To achieve the foregoing object, the invention provides a system of data management to manage correlated data records. In one embodiment, the inventive system comprises a data verification module, a data notation module, and a data management module. The data verification module verifies the data records according to the data correlations and produces verification results. Each verification result corresponds to a data record. The data notation module notes the verification results in the corresponding data records. The data management module manages the data records according to the verification results. The system may further comprise data application modules for application to the data records.

### BRIEF DESCRIPTION OF THE DRAWINGS

The present invention can be more fully understood by reading the subsequent detailed description and examples with references made to the accompanying drawings, wherein:

FIG. 1 is a diagram of a system of data management for correlated data records according to the present invention.

FIG. 2 is a flowchart of the method of data management for correlated data records according to the present invention.

FIG. 3 is a diagram of data correlations.

FIG. 4 is an example of data verification results.

FIG. 5 is a diagram of the inventive database.

### DETAILED DESCRIPTION OF THE INVENTION

As summarized above, the present invention provides a system overcoming conventional data management problems. The inventive system includes a data verification module, a data notation module, and a data management module. The system further comprises several data application modules.

The data verification module verifies data records according to data correlations and produces verification results. Each verification result corresponds to a data record. The verification results include at least one of valid, invalid, and expired. A data record is valid if the data record can be applied to the data application modules, and invalid if the data record cannot be applied to the data application modules, such as locking of some data fields. A data record is considered expired if the data record is overdue.

The data notation module notes the produced verification results in the corresponding data records, as data preparation conditions. The data management module manages the data records according to the verification results.

The data correlations are established according to correlations or processing order between the data records as applied to the data application modules. The data correlations may be sequential, parallel, or both. By way of explanation, three data records data, record A, data record B, and data record C are to be applied to a data application module. If data record B is made available only after data record A is available, then the data correlation between data record A and B is sequential. If data record A and data record B must be prepared before application to the data application module, but there are no correlations between data record A and data record B, then the data correlation between data record A and B is considered parallel. If data record C will be valid only after data records A and B are valid for application to the data application module, and data records B and C have parallel data correlation, then the data correlation between data record A, B and C is sequential and parallel. The data correlation can be implemented as a tree structure or rule-based conditional statements.

The data records are stored in databases. Each data record has a data record owner, responsible for data record preparation. Thus, the data management module sends the verification results to the data record owners for data management. The data owners can modify or maintain their own data records according to the received verification results. The data management module may directly delete the data records from the database.

Moreover, the invention provides a method of data management for a plurality of correlated data records. First, the data records are verified according to the data correlations, producing verification results. Here, each verification result corresponds to a data record.

Next, the verification results are noted in the corresponding data records. Finally, the data records are managed according to the verification results, after which they are applied to data application modules.

Here, the data correlations are similar as mentioned. The data records are stored in database. Each data record has a data record owner, responsible for preparation. Thus, the data management module sends the verification results to the data record owners or deletes the data records directly to accomplish data management.

In addition, the invention provides a database comprising a data storage module and a data operation module. The data storage module stores correlated data records. The data operation module operates the data records.

The data management module includes a data verification module, a data notation module, and a data management module. The data verification module verifies the data records according to the data correlations and produces verification results, each of which corresponds to a data record. The data notation module notes the verification results in the corresponding data records.

The data management module manages the data records according to the verification results. The system further comprises data application modules for application to the data records.

Again, the data correlations are similar as mentioned. Each data record has a data record owner, responsible for the data record preparation. Thus, the data management module sends the verification results to the data record owners or deletes the data records to accomplish data management.

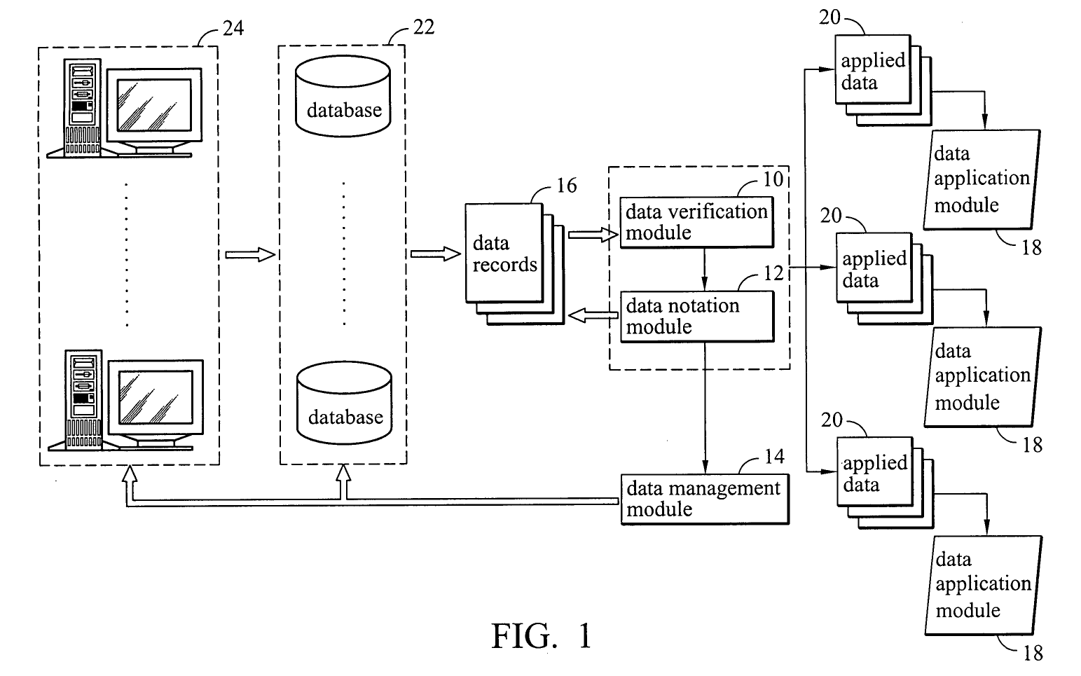

FIG. 1 is a diagram of the system of data management to manage correlated data records. The inventive system includes a data verification module 10, a data notation module 12, and a data management module 14. The data verification module 10 verifies the data records 16 according to correlations and produces verification results. Each verification result corresponds to a data record. The data notation module 12 notes the verification results in the corresponding data records. The data management module 14 manages the data records according to the verification results. The system further comprises data application modules 18 for application to the data records.

The data records 16 are stored in databases 22. Each data record has a data record owner 24, responsible for the data preparation. The data management module 14 sends the verification results to the data record owners 24 for data management. Otherwise, the data management module 14 deletes the data records from the databases 22 directly for data management. Databases 22 can be designed as several databases according to different functions or a single integrated database.

The data correlations are established according to correlations between the data records applied to the data application modules 18. The data correlations may be sequential, parallel, or both.

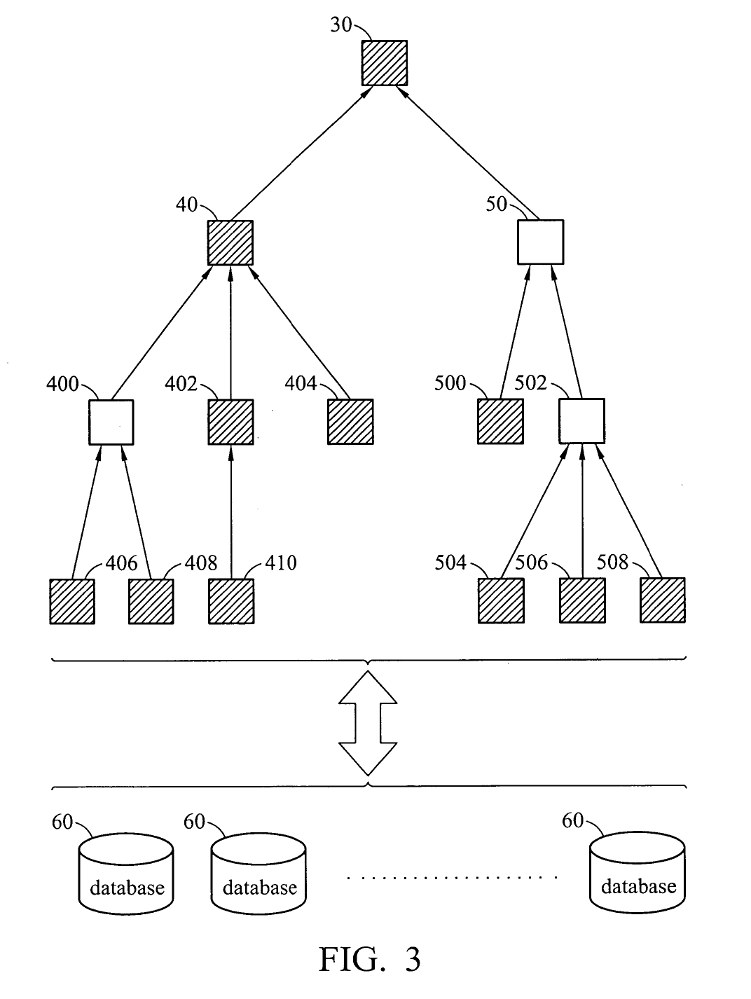

FIG. 3 is a diagram of data correlations. In one embodiment, the tree structure is utilized to represent the data correlations. Node 30 depends on node 40 and 50. The data correlation between nodes 40, 50 and 30 is sequential. If there are no data correlations between node 40 and node 50, then the data correlation therebetween is parallel.

Nodes with oblique lines, such as nodes 30, 40, imply the actual data records. The blank nodes, such as 50 and 400, indicate the nodes as check points for combining the actual data records. Similarly, node 50 is available only if nodes 500 and 502 are available. The data correlation between node 50 and node 500, 502 is sequential. Node 50 does not imply the actual data record, but a check point for data availability. Node 502 is available only if nodes 504, 506 and 508 are available. Thus, the data correlation between node 502 and node 504, 506, and 508 is sequential. Nodes 40, 400, 402, 404, 406, 408, and 410 are similar as mentioned. All the applied data records are obtained from databases 60. Databases 60 can be designed into several different databases according their functions or a single integrated database.

As an example, if an enterprise desires to establish a data application system, referring to FIG. 1, the data owners 24 prepare data records in databases 22. Data verification module 10 retrieves and verifies data records 16 from the databases 22 according to established data correlations. Verification results will be produced after data verification. Data notation module 12 then notes the verification results in the corresponding data records 16. The verification results also provide information to data application modules 18. Before the data records are applied to the data application modules 18, it is ensured that the applied data 20 is complete, correct, and valid. Data management module 14 sends the verification results to the data owners for data management. The data management module 14 may delete data records from the databases 22 directly. Thus, the accuracy, integrity, and validity of the applied data can be ensured before processing by data application modules, enhancing the stability of the data application system.

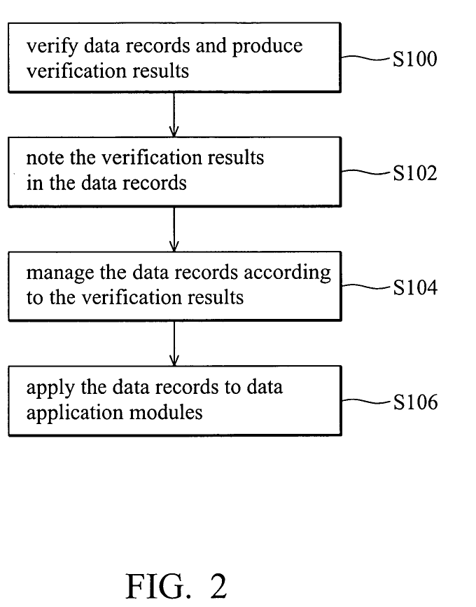

FIG. 2 is a flowchart of the method of data management for correlated data records. First, the inventive method verifies the data records according to the data correlations and produces verification results (step S100). Each verification result corresponds to a data record. Next, the verification results are noted in the corresponding data records (step S102), data records are managed according to the verification results (step S104), and finally, data records are applied to data application modules (step S106).

Here, the data correlations are similar as mentioned. The data records are stored in databases. Each data record has a data record owner, responsible for the data record preparation. Thus, the verification results are sent to the data record owners for data management. The data records may be deleted directly for data management.

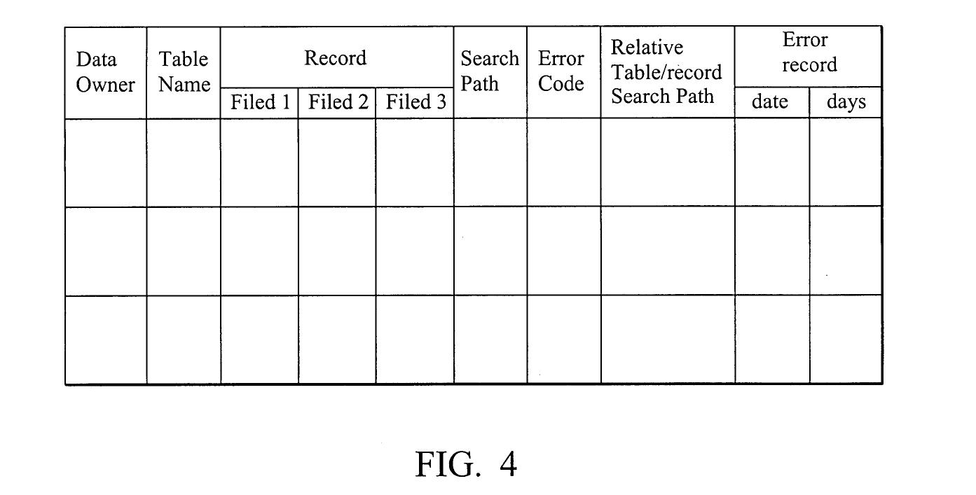

FIG. 4 is an example of data verification result. In one embodiment, the verification result is represented in a table. The table indicates the data owners and the error information of corresponding data records. Data owners can modify or maintain their own data records according to the verification result. Thus, the data records can be tracked and maintained by the data record owners through the verification results, reducing the number of invalid data records in the databases.

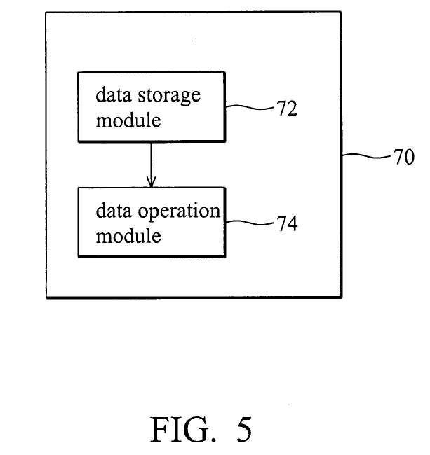

FIG. 5 is a diagram of the inventive database, comprising a data storage module 72 and a data operation module 74. The data storage module 72 stores correlated data records. The data operation module 74 operates the data records. The data operation module 74 includes a data verification module, a data notation module, and a data management module. The functions of the modules are as mentioned and the detailed diagram of the data operation module as shown in FIG. 1. The database 70 can be designed as several separate databases according to functions or a single integrated database. The database 70 can also be integrated into any data application system, or operated solely for data storage for an enterprise.

It will be appreciated from the foregoing description that the system and method described herein provide a dynamic and robust solution to data preparation problems for a data application system. If, for example, the data application system changes data application programs, the system and method of the present invention can be revised accordingly.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A system of data management for a plurality of correlated data records, comprising:
a data verification module, verifying the data records according to the data correlations and producing a plurality of verification results, each of which corresponds to a data record;
a data notation module, coupled to the data verification module, noting the verification results in the corresponding data records; and
a data management module, coupled to the data notation module, managing the data records according to the verification results.

2. The system as claimed in claim 1, further comprising at least one data application module, coupled to the data verification module and the data notation module, applying the data records.

3. The system as claimed in claim 2, wherein the data correlations are established according to correlations between the data records applied to the data application modules.

4. The system as claimed in claim 3, wherein the data correlations are sequential.

5. The system as claimed in claim 3, wherein the data correlations are parallel only.

6. The system as claimed in claim 3, wherein the data correlations are both sequential and parallel.

7. The system as claimed in claim 1, wherein each data record has a data record owner.

8. The system as claimed in claim 7, wherein data management is enabled by the data management module sending the verification results to the data record owners.

9. The system as claimed in claim 7, wherein data management is enabled by the data management module deleting the data records.

10. The system as claimed in claim 1, wherein the data records are stored in at least one database.

11. A method of data management for a plurality of correlated data records, comprising:
verifying the data records according to the data correlations and producing a plurality of verification results, each of which corresponds to a data record;
noting the verification results in the corresponding data records; and
managing the data records according to the verification results.

12. The method as claimed in claim 11, further comprising applying the data records to at least one data application module.

13. The method as claimed in claim 12, wherein the data correlations are established according to correlations between the data records applied by the data application modules.

14. The method as claimed in claim 13, wherein the data correlations are sequential only.

15. The method as claimed in claim 13, wherein the data correlations are parallel only.

16. The method as claimed in claim 13, wherein the data correlations are both sequential and parallel.

17. The method as claimed in claim 11, wherein each data record has a data record owner.

18. The method as claimed in claim 17, wherein data management is enabled by the data management module sending the verification results to the data record owners.

19. The method as claimed in claim 17, wherein data management is enabled by the data management module deleting the data records.

20. The method as claimed in claim 11, wherein the data records are stored in at least one database.

21. A database, comprising:
a data storage module, storing a plurality of correlated data records, and
a data operation module, coupled to the data storage module, operating the data records.

22. The database as claimed in claim 21, wherein the data operation module further comprises:
a data verification module, verifying the data records according to the data correlations and producing a plurality of verification results, each of which corresponds to a data record;
a data notation module, coupled to the data verification module, noting the verification results in the corresponding data records; and
a data management module, coupled to the data notation module, managing the data records according to the verification results.

23. The database as claimed in claim 22, wherein the data management module further comprises at least one data application module, coupled to the data verification module and the data notation module, and applying the data records.

24. The database as claimed in claim 22, wherein the data correlations are established according to correlations between the data records applied to the data application modules.

25. The database as claimed in claim 24, wherein the data correlations are sequential only.

26. The database as claimed in claim 24, wherein the data correlations are parallel only.

27. The database as claimed in claim 24, wherein the data correlations are both sequential and parallel.

28. The database as claimed in claim 22, wherein each data record has a data record owner.

29. The database as claimed in claim 28, wherein data management is enabled by the data management module sending the verification results to the data record owners.

30. The database as claimed in claim 28, wherein data management is enabled by the data management module deleting the data records.
